(19) United States
(12) Patent Application Publication
(10) Pub. No.: US 2026/0225377 A1
(43) Pub. Date: Aug. 6, 2026

(54) PRINTER

(71) Applicant: BROTHER KOGYO KABUSHIKI KAISHA, Nagoya (JP)

(72) Inventors: Yushi KATO, Nagoya (JP); Sho ASAI, Nagoya (JP); Yohsuke HATA, Nagoya (JP); Tetsuro MURAMATSU, Nagoya (JP)

(21) Appl. No.: 19/462,772

(22) Filed: Jan. 28, 2026

(30) Foreign Application Priority Data
Jan. 31, 2025 (JP) 2025-014739

(51) Int. Cl. B41J 2/35; B41J 3/407; B41J 11/00; B41J 11/04; B41J 11/14; B41J 15/04; B41J 29/00

(52) U.S. Cl. CPC B41J 2/35; B41J 3/4075; B41J 11/003; B41J 11/04; B41J 11/14; B41J 15/042; B41J 29/00

(57) ABSTRACT

A printer includes a head, a platen roller, a motor, a housing portion, and a reader. The motor is configured to drive the platen roller. The housing portion is configured to house a support member. The support member supports the medium and includes a first memory. The reader is configured to read out data. The data is stored in the first memory of the support member and includes identification data for determining a motor current. The motor current is a current to drive the motor. The printer performs first determination and first drive processing. The first determination processing determines the motor current based on the identification data read out from the first memory by the reader. The first drive processing drives the motor based on the motor current determined by the first determination processing.

### REFERENCE TO RELATED APPLICATIONS

This application claims priority from Japanese Patent Application No. 2025-014739 filed on Jan. 31, 2025. The entire content of the priority application is incorporated herein by reference.

### BACKGROUND ART

A label creation device includes a housing and an upper cover. A head and a housing portion are provided in the housing. A roll, on which a print medium is wound in a roll shape, is housed in the housing portion. A platen roller is provided on the upper cover.

In a state of the upper cover being closed, the print medium is clamped between the platen roller and the head. A driven gear connected to the platen roller meshes with a main gear housed in the housing. The platen roller rotates via the main gear and the driven gear, in accordance with the main gear being rotated by a motor. The platen roller pulls out the print medium from the roll and conveys the print medium. As a result of the head being heated in this state, printing is performed on the print medium.

### SUMMARY

A contact surface area between the platen roller and the head, and a contact surface area between the platen roller and the print medium change depending on the change of widths of the print medium. A torque of the motor required to convey the print medium using the platen roller changes depending on the change in the contact surface areas. Thus, when the motor is driven such that the torque is constant, depending on the width of the print medium, the print medium cannot be appropriately conveyed by the platen roller. When the motor driving the platen roller is controlled such that the torque is constant in this manner, depending on print conditions, the print medium cannot be appropriately conveyed.

An object of the present disclosure is to provide a printer that contributes to performing printing while appropriately conveying a print medium using a platen roller, even when print conditions differ.

A printer according to an aspect of the present disclosure includes a head, a platen roller, a motor, a housing portion, a reader, a processor, and a second memory. The head is configured to perform printing on a medium. The platen roller is configured to clamp the medium between the platen roller and the head and to convey the medium. The motor is configured to drive the platen roller. The housing portion is configured to house a support member. The support member supports the medium and includes a first memory. The reader is configured to read out data. The data is stored in the first memory of the support member housed in the housing portion and includes identification data for determining a motor current. The motor current is a current to drive the motor. The processor is configured to control the reader, the head, and the motor. The second memory stores computer-readable instructions that, when executed by the processor, instruct the processor to perform processes. The processes include first determination and first drive processing. The first determination processing determines the motor current based on the identification data read out from the first memory by the reader. The first drive processing drives the motor based on the motor current determined by the first determination processing.

In the present disclosure, the support member includes the first memory that stores the identification data for determining the motor current. Based on the identification data read out from the first memory, the printer determines the motor current and drives the motor. In this case, since the printer optimizes the motor current in accordance with print conditions, the printer contributes to performing printing while appropriately conveying the medium using the platen roller.

### BRIEF DESCRIPTION OF DRAWINGS

FIG. 1 is a perspective view of a printer in which a cover is disposed in a closed position.

FIG. 2 is a perspective view of the printer in which the cover is disposed in an open position.

FIG. 3 is a cross-sectional view of the printer.

FIG. 4 is a block diagram showing an electrical configuration of the printer.

FIG. 5 is a view showing a motor table.

FIG. 6 is a view showing a head table.

FIG. 7 is a flowchart showing main processing.

### DESCRIPTION

An embodiment of the present disclosure will be described with reference to the drawings. The referenced drawings are used to illustrate technological features that is adopted by the present disclosure. Illustrated configurations of devices are not intended to limit the present disclosure to the embodiment alone, and are simply explanatory examples.

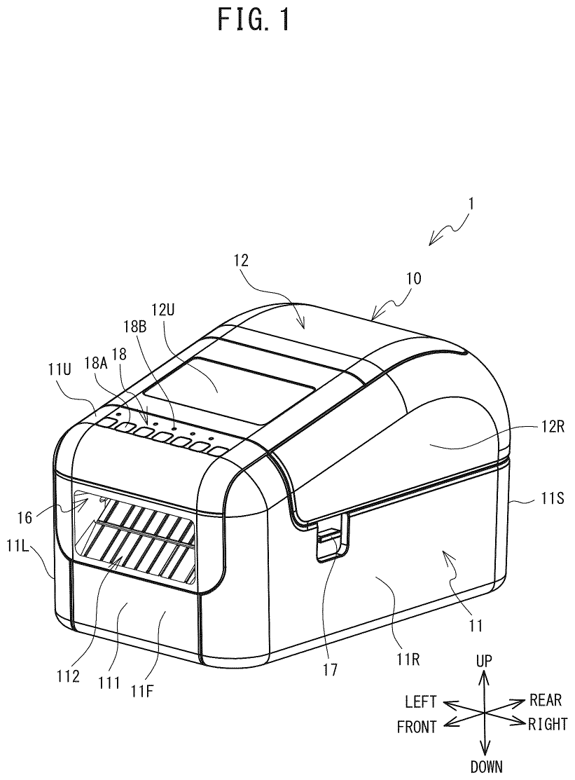

An upward direction, a downward direction, a lower left direction, an upper right direction, an upper left direction, and a lower right direction in FIG. 1 are an upward direction, a downward direction, a forward direction, a rearward direction, a leftward direction, and a rightward direction of a printer 1.

### Overview of Printer 1

The printer 1 performs printing using a thermosensitive method. The printer 1 pulls out a medium 92 from a roll 90 on which the medium 92 is wound. Using a head 14, the printer 1 heats the medium 92 pulled out from the roll 90. In this way, the medium 92 develops color, and the medium 92 is thus printed.

Further, using a cutter unit 15, the printer 1 separates a print section, which includes a section of the medium 92 that has been printed, from the roll 90. In this way, the print section is formed as a label.

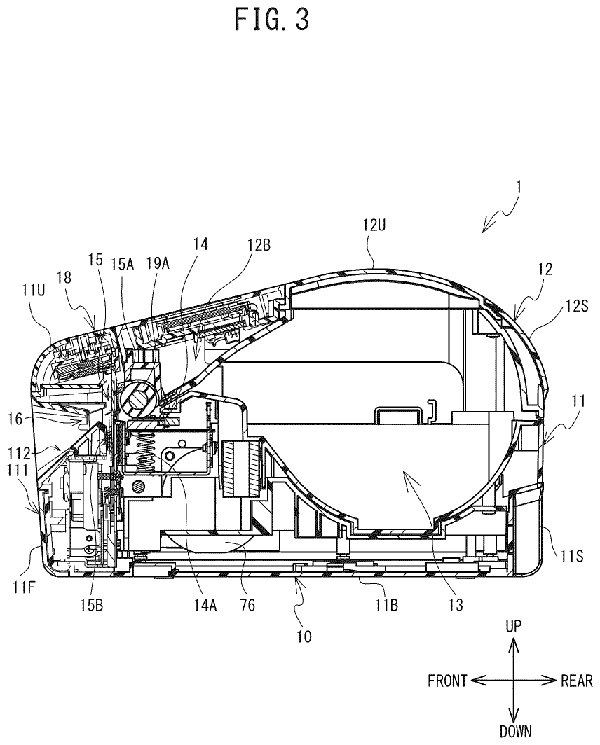

As shown in FIG. 1 to FIG. 3, the printer 1 includes a housing 10. The housing 10 includes a main body 11 and a cover 12.

The main body 11 includes a front wall portion 11F, a rear wall portion 11S, a left wall portion 11L, a right wall portion 11R, an upper wall portion 11U, and a lower wall portion 11B.

The front wall portion 11F includes a first wall portion 111 orthogonal to the front-rear direction, and a second wall portion 112 extending from the first wall portion 111 toward the inside of the housing 10. A discharge port 16, from which the print section of the medium 92 is discharged, is provided at an end portion of the second wall portion 112 on the inner side. The print section including the section of the medium 92 that has been printed is discharged from the discharge port 16. The cover 12 is rotatably supported at the upper end of the rear wall portion 11S.

An interface panel 18 is provided at the upper wall portion 11U. The interface panel 18 includes a plurality of push buttons 18A and a plurality of LEDs 18B. The push buttons 18A are operated when a user performs an input operation to the printer 1. The LEDs 18B notify a state of the printer 1. A lever 17, which is operated when opening the cover 12, is provided at the right wall portion 11R.

The main body 11 internally includes a housing portion 13. The housing portion 13 is formed as a space for housing a roll unit 9.

The roll unit 9 includes the roll 90 and a roll support member 91.

The roll support member 91 rotatably supports the roll 90. The roll support member 91 includes a core passing through the center of the roll 90, and flanges 91L and 91R provided on both sides of the core. The flange 91L is disposed to the left of the roll 90. The flange 91R is disposed to the right of the roll 90.

A memory 96 is provided at the right surface of the flange 91R. The memory 96 is a non-volatile memory. At least identification data indicating the width of the medium 92 is stored in the memory 96.

Unit support portions 13L and 13R are provided in the housing portion 13 of the printer 1. The unit support portion 13L supports the flange 91L of the roll unit 9 in a state of being housed in the housing portion 13. The unit support portion 13R supports the flange 91R of the roll unit 9 in the state of being housed in the housing portion 13.

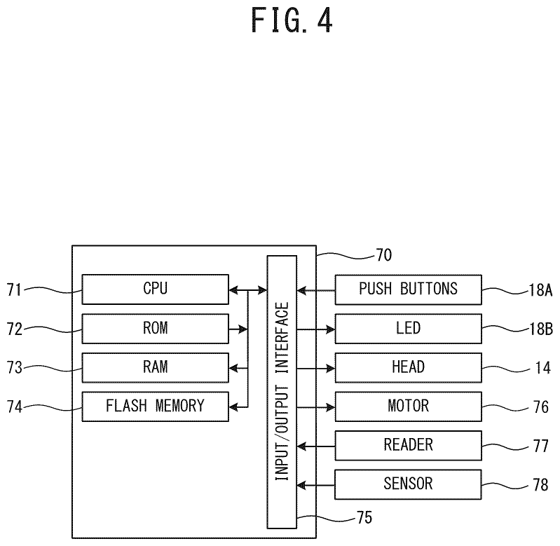

A reader 77 and a sensor 78 shown in FIG. 4 are provided at the left surface of the unit support portion 13R.

The reader 77 includes an electrode. The electrode of the reader 77 is electrically connected to an electrode of the memory 96 when the roll unit 9 is housed in the housing portion 13. The reader 77 reads the identification data stored in the memory 96, via the electrode.

The sensor 78 is a contact sensor. The sensor 78 outputs differing signals when the roll unit 9 is housed in the housing portion 13 and when the roll unit 9 is not housed in the housing portion 13. The sensor 78 is used to detect whether the roll unit 9 is housed in the housing portion 13.

The head 14 is provided at the front of the housing portion 13. The head 14 includes a plurality of heating elements on an upper surface of the head 14. The head 14 is urged in the upward direction by a spring 14A connected to a lower end of the head 14.

The cutter unit 15 is provided to the front of the head 14 and to the rear of the discharge port 16. The cutter unit 15 includes cutters 15A and 15B. The medium 92 passes in the forward direction between the cutters 15A and 15B. By moving in directions in which the cutters 15A and 15B approach each other, the cutters 15A and 15B cut the medium 92. In this way, the print section of the medium 92 is cut away from the roll 90.

Upper ends of the front wall portion 11F, the rear wall portion 11S, the left wall portion 11L, and the right wall portion 11R, and the rear end of the upper wall portion 11U form an opening 110 in the main body 11. In a state in which the printer 1 is placed on a placement surface, the lower wall portion 11B faces the placement surface.

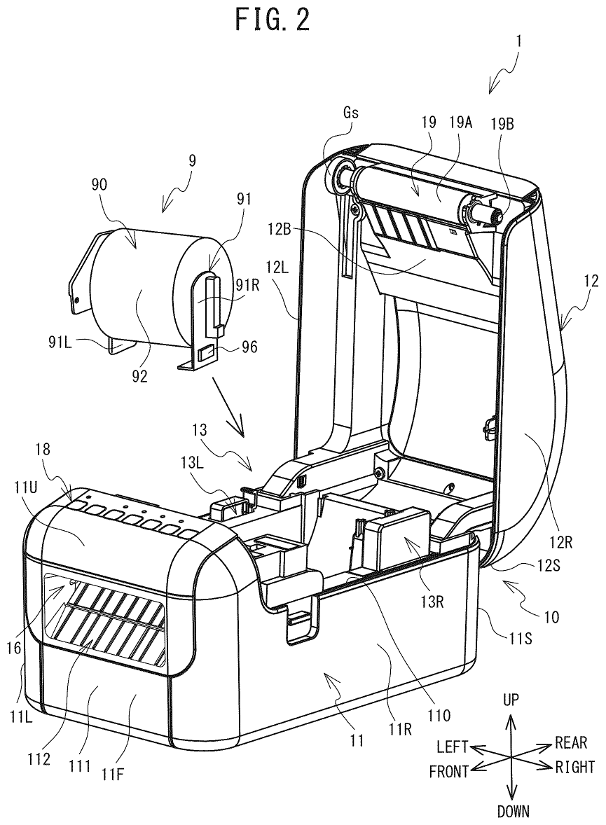

The cover 12 can move between a closed position in which the cover 12 closes the opening 110 of the main body 11, and an open position in which the cover 12 does not close the opening 110. FIG. 1 shows a state in which the cover 12 is disposed in the closed position. FIG. 2 shows a state in which the cover 12 is disposed in the open position. Hereinafter, where not otherwise particularly described, directions of the cover 12 (the upward direction, the downward direction, the forward direction, the rearward direction, the leftward direction, and the rightward direction) are described assuming the state in which the cover 12 is disposed in the closed position.

The cover 12 includes an upper wall portion 12U, a left wall portion 12L, a right wall portion 12R, and a rear wall portion 12S.

The upper wall portion 12U is disposed to the rear of the upper wall portion 11U of the main body 11. The left wall portion 12L is disposed above the left wall portion 11L of the main body 11. The right wall portion 12R is disposed above the right wall portion 11R of the main body 11. The rear wall portion 12S is disposed above the rear wall portion 11S of the main body 11. The lower end of the rear wall portion 12S is rotatably supported at the upper end of the rear wall portion 11S of the main body 11.

The position of the cover 12 moves between the closed position and the open position in accordance with the rotation of the cover 12 with respect to the main body 11.

A platen assembly 19 is rotatably supported at the front end portion of the lower surface of the upper wall portion 12U. The platen assembly 19 includes a platen roller 19A, a shaft body 19B, and a driven gear Gs.

The platen roller 19A has a cylindrical column shape. The shaft body 19B includes a section protruding in the leftward direction from the left end portion of the platen roller 19A, and a section protruding in the rightward direction from the right end portion of the platen roller 19A. A shaft bearing 12B provided at the upper wall portion 12U of the cover 12 rotatably supports the shaft body 19B of the platen assembly 19.

The driven gear Gs is connected to a section, of the shaft body 19B, protruding in the leftward direction from the left end portion of the platen roller 19A.

In the state in which the cover 12 is disposed in the closed position, the platen roller 19A is disposed above the head 14. The driven gear Gs meshes with a main gear provided in the main body 11. The main gear is connected to a motor 76.

A driving force is transmitted to the platen roller 19A via the main gear and the driven gear Gs in accordance with the rotation of the motor 76. In this way, the platen roller 19A rotates, and pulls out the medium 92 from the roll 90.

The medium 92 pulled out from the roll 90 passes between the head 14 and the platen roller 19A. The head 14 is pressed against the medium 92 as a result of the head 14 receiving an urging force in the upward direction from the spring 14A. In this state, the plurality of heating elements of the head 14 are heated, and thus, the medium 92 develops color. In this way, the printing on the medium 92 is performed. The print section of the medium 92 is cut away from the roll 90 by the cutter unit 15, and is discharged from the discharge port 16.

### Electrical Configuration

The electrical configuration of the printer 1 will be described with reference to FIG. 4. The printer 1 includes a control board 70. A CPU 71, a ROM 72, a RAM 73, a flash memory 74, and an input/output interface 75 are connected to each other on the control board 70.

The CPU 71 controls the printer 1. The ROM 72 stores various parameters necessary when the CPU 71 executes various programs, a printer classification. The RAM 73 temporarily stores various information, such as arithmetic calculation results by the CPU 71. The flash memory 74 stores the programs executed by the CPU 71, and a motor table 741, a head table 742 to be described later.

The push buttons 18A, the LEDs 18B, the head 14, the motor 76, the reader 77, and the sensor 78 are connected to the input/output interface 75.

### Correlation Between Width of Medium 92 and Torque of Motor 76

The larger the width of the medium 92, the larger a contact surface area is between the platen roller 19A and the medium 92. Further, the platen roller 19A and the head 14 come into contact with each other at sections where the medium 92 is not interposed therebetween. Thus, the smaller the width of the medium 92, the larger a contact surface area is between the platen roller 19A and the head 14.

The larger the contact surface area between the platen roller 19A and the head 14, the greater the torque of the motor 76 required to rotate the platen roller 19A becomes. Thus, the torque of the motor 76 required to rotate the platen roller 19A becomes greater the smaller the width of the medium 92.

As a result, the motor 76 is preferably driven at a larger torque the smaller the width of the medium 92. In other words, an electric current for driving the motor 76 is preferably larger the smaller the width of the medium 92. Note that when the electric current for driving the motor 76 is not sufficient, the motor 76 may become out of step.

### Correlation Between Width of Medium 92 and Electric Current Conducted to Head 14

The larger the width of the medium 92, the larger a print area to be printed, and thus, a maximum value of the electric current conducted to the head 14 also increases. As a result, the maximum value of the electric current conducted to the head 14 is preferably set to be a larger value the larger the width of the medium 92. In other words, the maximum value of the electric current conducted to the head 14 is preferably set to be a smaller value the smaller the width of the medium 92.

Note that when the maximum value of the electric current conducted to the head 14 is not sufficient, it is necessary for the printer 1 to execute divided printing. In the divided printing, the print section in a main scanning direction is divided up into a plurality of sections. When the divided printing is executed, a time required to complete the printing becomes longer, compared to when the divided printing is not executed.

### Motor Table 741

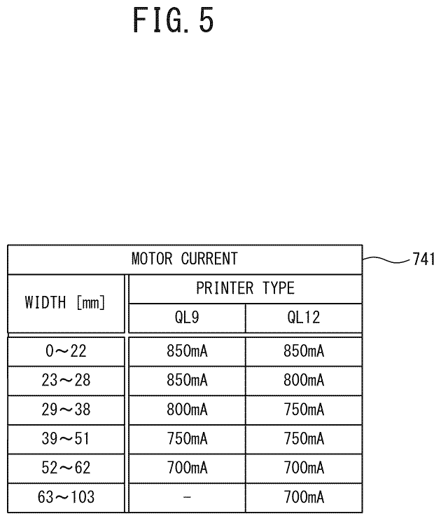

FIG. 5 shows the motor table 741 stored in the flash memory 74. In the motor table 741, a motor current is associated with each of the widths of the medium 92 and printer types. The motor current is the electric current for energizing the motor 76 to cause the motor 76 to rotate. In the motor table 741, the smaller the width of the medium 92, the larger a value of the motor current associated therewith.

### Head Table 742

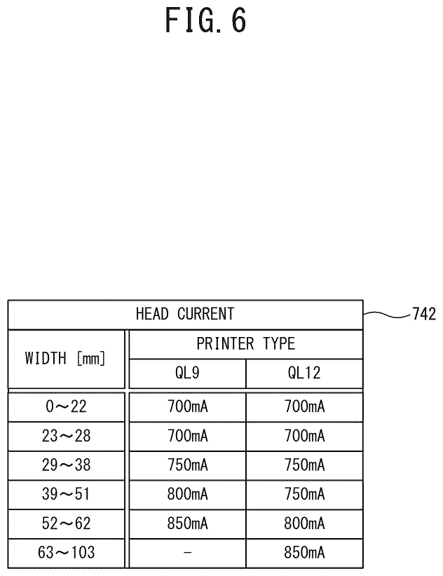

FIG. 6 shows the head table 742 stored in the flash memory 74. In the head table 742, a head current is associated with each of the widths of the medium 92 and the printer types. The head current is the maximum value of the electric current conducted to the head 14 when heating the plurality of heating elements of the head 14. In the head table 742, the smaller a width value, the smaller a value of the head current associated therewith.

### Main Processing

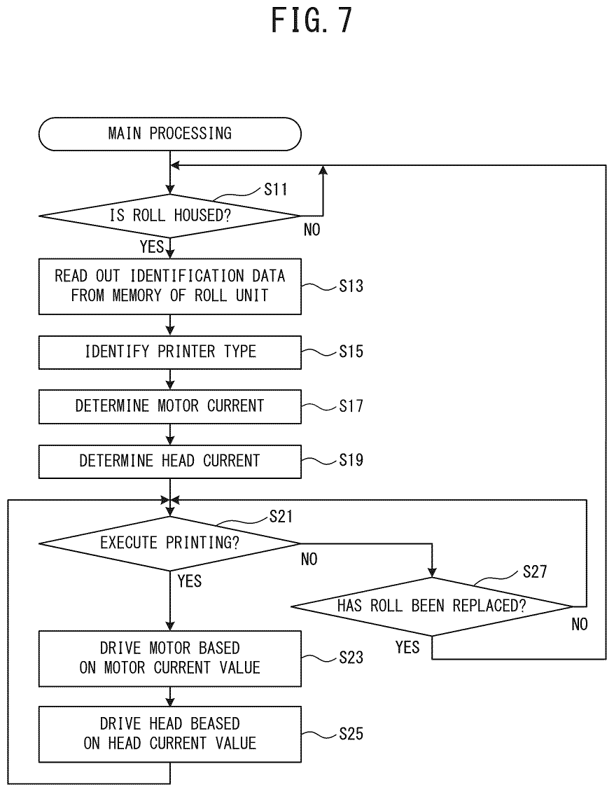

Main processing will be described with reference to FIG. 7. When a power source of the printer 1 is turned on, the CPU 71 starts the main processing by reading out and executing the program stored in the ROM 72.

Based on an output signal of the sensor 78, the CPU 71 determines whether the roll unit 9 is housed in the housing portion 13 (S11). When it is determined that the roll unit 9 is not housed (no at S11), the CPU 71 returns the processing to S11. When it is determined that the roll unit 9 is housed (yes at S11), the CPU 71 advances the processing to S13.

Using the reader 77, the CPU 71 reads out the identification data stored in the memory 96 of the roll unit 9 housed in the housing portion 13 (S13). The CPU 71 reads out the printer type from the ROM 72 and identifies its printer type (S15).

The CPU 71 refers to the motor table 741. The CPU 71 determines the motor current that is associated with the width of the medium 92 indicated by the identification data read out at S13 and the printer type identified at S15 (S17). In this way, the smaller the value of the width of the medium 92 of the roll unit 9 housed in the housing portion 13, the larger the value determined for the motor current.

The CPU 71 refers to the head table 742. The CPU 71 determines the head current that is associated with the width of the medium 92 indicated by the identification data read out at S13 and the printer type identified at S15 (S19). In this way, the smaller the value of the width of the medium 92 of the roll unit 9 housed in the housing portion 13, the larger the value determined for the head current.

The CPU 71 determines whether an operation to execute the printing has been detected via the push buttons 18A of the interface panel 18 (S21). When it is determined that the operation to execute the printing has been detected (yes at S21), the CPU 71 advances the processing to S23.

The CPU 71 drives the motor 76 based on the motor current determined at S17 (S23). More specifically, the CPU 71 performs control such that a current value of the electric current conducted to the motor 76 in order to rotate the motor 76 is the motor current determined at S17.

The driving force corresponding to the rotation of the motor 76 is transmitted to the platen roller 19A via the main gear and the driven gear Gas. In this way, the platen roller 19A rotates, and the medium 92 is pulled out from the roll 90 of the roll unit 9. The medium 92 passes between the head 14 and the platen roller 19A and is conveyed in the forward direction.

The CPU 71 drives the head 14 based on the head current determined at S19 (S25). More specifically, the CPU 71 performs control such that the maximum value of the electric current conducted to the head 14 is the head current determined at S19. The CPU 71 returns the processing to S21.

Due to the energization of the head 14, the plurality of heating elements of the head 14 generate heat and the medium 92 develops color. In this way, the printing is performed on the medium 92.

The CPU 71 repeats the processing at S21, S23, and S25 during a period in which the printing is being executed. When the printing is complete (no at S21), the CPU 71 drives the cutter unit 15. In this way, the print section of the medium 92 is cut away from the roll 90, and is discharged from the discharge port 16.

The CPU 71 determines whether an operation to replace the roll unit 9 has been performed (S27). When, based on the output signal from the sensor 78, the CPU 71 determines that the roll unit 9 has been continuously housed in the housing portion 13, the CPU 71 determines that the operation to replace the roll unit 9 has not been performed (no at S27). The CPU 71 returns the processing to S21.

When, based on the output signal from the sensor 78, the CPU 71 determines that the roll unit 9 is not housed in the housing portion 13, the CPU 71 determines that the operation to replace the roll unit 9 has been performed (yes at S27). The CPU 71 returns the processing to S11. When it is determined that the roll unit 9 is being housed in the housing portion 13 (yes at S11), the CPU 71 reads out the identification data from the memory 96 of the newly housed roll unit 9 (S13), and repeats the processing.

### Actions and Effects of Present Embodiment

The flange 91R of the roll support member 91 of the roll unit 9 includes the memory 96 that stores the identification data for determining the motor current. The printer 1 determines the motor current based on the identification data read out from the memory 96, and drives the motor 76 (S17, S23). In this case, since the motor current is optimized in accordance with the print conditions, the printer 1 contributes to performing the printing in which the medium 92 is appropriately conveyed by the platen roller 19A.

The identification data stored in the memory 96 includes the width of the medium 92. As a result, the printer 1 contributes to optimizing the motor current for each of the widths, when the plurality of medium 92 having differing widths are used. Thus, even when the plurality of medium 92 having the differing widths are used, the printer 1 contributes to performing the printing in which the medium 92 is appropriately conveyed by the platen roller 19A.

The smaller the width of the medium 92, the larger the motor current of the motor 76 required for the motor 76 not to become out of step. Here, the printer 1 determines the motor current to be larger the smaller the width of the medium 92, and drives the motor 76. In this way, the printer 1 contributes to performing the printing in which the plurality of medium 92 having the differing widths are appropriately conveyed by the platen roller 19A.

The smaller the width of the medium 92, the less the head current required when driving the head 14 to perform the printing. Here, the printer 1 determines the head current to be smaller the smaller the width of the medium 92, and drives the head 14 using the determined head current as the maximum value. In this way, the printer 1 contributes to optimizing the head current when the printing is performed on the plurality of medium 92 having the differing widths.

Note that when the maximum value of the electric current conducted to the head 14 is not sufficient, it is necessary for the printer 1 to execute the divided printing. Here, the printer 1 determines the larger head current the larger the width of the medium 92, and drives the head 14 using the determined head current as the maximum value. In this way, since the execution of the divided printing is suppressed, the printer 1 contributes to preventing a time required to complete the printing from increasing.

The printer 1 contributes to easily determining the appropriate motor current for each of the plurality of medium 92 having the differing widths by referring to the motor table 741.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

The present disclosure is not limited to the above-described embodiment, and various changes are possible. The printing method of the printer 1 is not limited to being the thermosensitive method, and may be a thermal ink-transfer printing method that performs the printing by heating an ink ribbon using the head 14.

The memory 96 of the roll unit 9 may store the motor current itself as the identification data. The printer 1 may drive the motor 76 based on the motor current indicated by the identification data read out from the memory 96. In this case, the printer 1 contributes to optimizing the motor current for each of the print conditions based on the roll unit 9. Thus, the printer 1 contributes to performing the printing in which the medium 92 is appropriately conveyed by the platen roller 19A.

Further, in this case, the motor current indicated by the identification data may be defined based on the width of the medium 92 of the roll unit 9 that includes the memory 96 storing the identification data. Furthermore, the identification data indicating the motor current that becomes larger the smaller the width of the medium 92 may be stored in the memory 96 of the roll unit 9. In this case, the printer 1 contributes to determining the motor current that is optimized for each of the widths of the medium 92 based on the identification data read out from the memory 96 of the medium 92, and driving the motor 76 accordingly.

The memory 96 of the roll unit 9 may store, as the identification data, data that is data other than the width of the medium 92 and the motor current, and that can be used to determine the motor current.

The widths of the medium 92 and the motor currents stored in the motor table 741 may have an inverse proportional relationship. The motor current stored in the motor table 741 need not necessarily become larger the smaller the width of the medium 92. For example, when the width of the medium 92 is smaller than a predetermined lower limit, or is larger than a predetermined upper limit, the motor current may be constant.

The width of the medium 92 and the head current stored in the head table 742 may have a proportional relationship. The head current stored in the head table 742 need not necessarily become larger the larger the width of the medium 92. For example, when the width of the medium 92 is smaller than a predetermined lower limit, or is larger than a predetermined upper limit, the head current may be constant.

The printer 1 may calculate the motor current by applying a predetermined coefficient to the width of the medium 92 read out from the memory 96. The printer 1 may calculate the head current by applying a predetermined coefficient to the width of the medium 92 read out from the memory 96.

### Other

The memory 96 is an example of a “first memory” of the present disclosure. The roll support member 91 is an example of a “support member” of the present disclosure. The CPU 71 is an example of a “processor” of the present disclosure. The processing at S17 is an example of “first determination processing” of the present disclosure. The processing at S23 is an example of “first drive processing” of the present disclosure. The processing at S19 is an example of “second determination processing” of the present disclosure. The processing at S25 is an example of “second drive processing” of the present disclosure. The motor table 741 is an example of a “table” of the present disclosure. The flash memory 74 storing the motor table 741 is an example of a “second memory” of the present disclosure. The memory 96 is an example of a “first memory” of the present disclosure. The ROM 72 is an example of a “second memory” of the present disclosure.

What is claimed is:

1. A printer comprising:
a head configured to perform printing on a medium;
a platen roller configured to clamp the medium between the platen roller and the head and to convey the medium;
a motor configured to drive the platen roller;
a housing portion configured to house a support member, the support member supporting the medium and including a first memory;
a reader configured to read out data, the data being stored in the first memory of the support member housed in the housing portion and including identification data for determining a motor current, the motor current being a current to drive the motor;
a processor configured to control the reader, the head, and the motor; and
a second memory storing computer-readable instructions that, when executed by the processor, instruct the processor to perform processes comprising:
first determination processing of determining the motor current based on the identification data read out from the first memory by the reader; and
first drive processing of driving the motor based on the motor current determined by the first determination processing.

2. The printer according to claim 1, wherein
the data includes the identification data relating to a width of the medium.

3. The printer according to claim 1, wherein
the data includes the identification data relating to the motor current.

4. The printer according to claim 3, wherein
the data includes the identification data relating to the motor current defined based on a width of the medium.

5. The printer according to claim 2, wherein
the first determination processing includes determining the motor current to be larger the smaller the width of the medium.

6. The printer according to claim 4, wherein
the first determination processing includes determining the motor current to be larger the smaller the width of the medium.

7. The printer according to claim 5, wherein
the processor further performs processes comprising:
second determination processing of determining a head current being a current to drive the head, based on the identification data read out from the first memory by the reader; and
second drive processing of driving the head based on the head current determined by the second determination processing, wherein
the second determination processing includes determining the head current to be smaller the smaller the width of the medium.

8. The printer according to claim 6, wherein
the processor further performs processes comprising:
second determination processing of determining a head current being a current to drive the head, based on the identification data read out from the first memory by the reader; and
second drive processing of driving the head based on the head current determined by the second determination processing, wherein
the second determination processing includes determining the head current to be smaller the smaller the width of the medium.

9. The printer according to claim 2, wherein
the second memory stores a table defining the motor current for each of the widths of the medium indicated by the identification data, and
the first determination processing includes determining, based on the table stored in the second memory, the motor current corresponding to the width of the medium indicated by the identification data read out from the first memory by the reader.
